(19) United States
(12) Patent Application Publication
(10) Pub. No.: US 2011/0252107 A1
(43) Pub. Date: Oct. 13, 2011

(54) Systems and Methods for Sending an Electronic Mail Communication at a Selected Time Based on the Recipient's Time Zone

(75) Inventors: Ben Chestnut, Atlanta, GA (US); Mark Armstrong, Smyrna, GA (US); Chadwick Morris, Marietta, GA (US)

(73) Assignee: THE ROCKET SCIENCE GROUP, LLC, Atlanta, GA (US)

(21) Appl. No.: 13/140,153

(22) PCT Filed: Dec. 16, 2009
(86) PCT No.: PCT/US09/68333

§ 371 Date: Jun. 16, 2011

Related U.S. Application Data
(60) Provisional application No. 61/122,840, filed on Dec. 16, 2008.

(51) Int. Cl. G06F 15/16

(52) U.S. Cl. 709/206

(57) ABSTRACT

Methods and systems for sending an email so recipients receive it at a selected time in respective time zones. Information about recipients may determine times zones. Information may include zip code, IP address, or identification of a server or service provider serving a recipient. Information may be based on a recipient's activity such as determination of a time zone in which more emails are received than any other, or having a highest weighted average (based on frequency of email receipt and recent history). The email is sent so recipients receive it at the selected time in the respective time zone. Recipients may be grouped by time zones. After sending the email to the recipients, open/click rates of the email by the recipients by the determined time zones may be determined and displayed on a time zone map.

### RELATED APPLICATION

This application claims priority to and the benefits of the prior filed co-pending and commonly owned provisional application entitled: SYSTEMS AND METHODS FOR SENDING AN ELECTRONIC MAIL COMMUNICATION AT A SELECTED TIME BASED ON THE RECIPIENT'S TIME ZONE, which was filed with the United States Patent and Trademark Office on Dec. 16, 2008, which was assigned U.S. Application Ser. No. 61/122,840, and which is incorporated herein by reference.

### FIELD OF THE INVENTIONS

The inventions relate to the communication of information. More particularly, the inventions relate to the timing of the transmission of communications.

### BACKGROUND

The present has been referred to as the Information Age. But too much information may mean that at least some of it may be ignored, overlooked, lost or otherwise not received or reviewed. A communicator may try to make sure its message is not beset by the previously mentioned problems. For example, a communicator may try to send its message at a time that the message is most likely to be received and reviewed by the recipient. Determining a “likely time” for a message to be sent may be relatively simple. Communicating the message at the selected likely time may be more difficult given the respective physical locations of the sender and the recipient. The difficulties in timely communication are multiplied when there is to be more than one recipient in more than one location. Thus, there is a need for systems and methods that allow for timely delivering of messages no matter the respective physical locations of the recipients.

### SUMMARY

The inventions are described herein with reference to exemplary embodiments, alternative embodiments, and also with reference to the attached drawings. The inventions, however, may be embodied in many different forms and carried out in a variety of ways, and should not be construed as limited to the embodiments set forth in this description and/or the drawings. The exemplary embodiments that are described and shown herein are only some of the ways to implement the inventions. Elements and/or actions of the inventions may be assembled, connected, configured, and/or taken in an order different in whole or in part from the descriptions herein.

Generally stated, the inventions may be implemented in exemplary embodiments. An exemplary method according to the inventions may provide for sending an electronic mail message (email) so that a recipient receives the email at a selected time in the recipient's time zone. Per this method, an instruction may be received to send an email to a recipient for receipt at a selected time where the time zone of the recipient is unknown. Information is obtained about the recipient to determine the unknown time zone. The information may include a zip code of the recipient or an area code. The obtained information may include an Internet Protocol (IP) address of the recipient. The IP address may be used to identify a server or an internet service provider (ISP) serving the IP address. The identity of the server or the ISP may be used to determine a location for the server or the ISP. The location for the server or the ISP may be used to determine the unknown time zone. The obtained information is used to determine the unknown time zone. The email is transmitted to the recipient so the recipient receives the email at the selected time in the determined time zone.

Another exemplary embodiment according to the inventions may provide a method to deliver an email so recipients receive the email at a selected time according to their respective time zones. This method may obtain information about each of the recipients. The information may be obtained by monitoring email activity of a particular recipient. Based on the monitoring, a determination may be made in which time zones the particular recipient receives emails. A further determination may be made as to which particular time zone the particular recipient receives more emails than any other time zone. Alternatively, a determination may be made as to which time zone has the highest weighted average among the determined time zones. The time zone having the highest weighted average may be determined based on frequency of receipt of emails in that time zone and recent history of receipt of email campaigns in that time zone.

The obtained information may be used to determine respectively a time zone for as many recipients as possible. If a time zone cannot be determined for a recipient, a default time zone may be selected for that recipient. The email is sent to the recipients so the recipients receive the email at the selected time according to their respectively determined time zones or to the default time zone. The recipients may be grouped according to their time zones. The email may be sent to the recipients in earliest time zone at the selected time in the earliest time zone.

The exemplary method also may provide for actions after sending the email. The exemplary method may monitor open and/or click rates of the email by the recipients by the determined time zones. The open and/or click rates may be displayed by the determined time zones on a map of time zones.

Another exemplary method provided by the inventions relates to a method to increase likelihood of a recipient opening an email. By this method, a time determined to be most likely at which the recipient is going to open the email is received. A time zone for the recipient is determined. The email is transmitted to the recipient at the determined time according to the determined time zone of the recipient. Determining the time zone for the recipient may involve determining the time zone from received information about the recipient. The received information may include zip code information, an internet protocol address relating to the recipient, or email activity of the recipient.

### BRIEF DESCRIPTION OF THE DRAWINGS

FIG. 1 is a flow diagram relating to an exemplary embodiment of the inventions.

FIG. 2 is a flow diagram relating to an exemplary embodiment of the inventions.

FIG. 3 is a flow diagram relating to an exemplary embodiment of the inventions.

FIG. 4 is a flow diagram relating to an exemplary embodiment of the inventions.

FIG. 5 is a graphic example of how information about open/click rates of an email may be displayed on a map of time zones.

### DETAILED DESCRIPTION

Generally stated, the inventions relate to methods and systems for sending an electronic mail communication or message (email)¹ so that a recipient² receives the email at a selected time whatever the recipient's time zone. For example, assume 9:00 AM is the selected time. An embodiment of the inventions may be used to send an email so that a recipient receives the email at 9:00 AM in his or her time zone. If the email is sent to a list of recipients, then each recipient on the list receives the email at 9:00 AM in his or her respective time zone. ¹ The term “email” is used broadly herein to encompass any kind of electronic message no matter how transmitted and/or received and without regard generally to its contents.² The term “recipient” or “subscriber” is used herein to identify the entity that is receiving an email communication. In describing the invention, the recipient is considered a “person” who reads or views the email communication (or at least notice thereof). Yet, reference is made to “recipient information” such as an IP address. A person does not have an IP address. In this case, the IP address is the address of the device being used by the person corresponding to the person's email address. A zip code is associated with a geographic area rather than a particular device. A “recipient's zip code” is considered the area within which the device identified by the recipient based on his or her email address is located.

A sponsor of an email campaign may benefit from an embodiment of the inventions that sends an email to recipients on the sponsor's list, but sends the email according to the respective recipients' time zones. As an example, consider a campaign sponsor that includes information and a coupon about a breakfast cereal in an email to be distributed to a large list of recipients spread around the world. The email campaign may have a better click and/or open rate if the email is received around the respective breakfast times of recipients in the various time zones around the world. In other words, the campaign sponsor may be more successful in delivering information about a product or service to a recipient when the information arrives at a pertinent time with respect to the subject matter of the information. An embodiment of the inventions allows an email to be sent around the world for delivery so the email arrives at a designated time with respect to the time zones of the respective recipients.

The inventions may include embodiments that collect information about an email campaign, and this information may be sorted according to time zone. The campaign information may be provided to (or by) a campaign sponsor in any form. An embodiment of the inventions provides the campaign information through use of a time zone map of the world. The campaign information such as statistics may be displayed on the time zone map. Particularly, the campaign information for each time zone may be displayed on the time zone map somewhere in or associated with the time zone to which the campaign information relates. Thus, a quick glance at the time zone map with the campaign information by time zone may be enough to absorb the information.

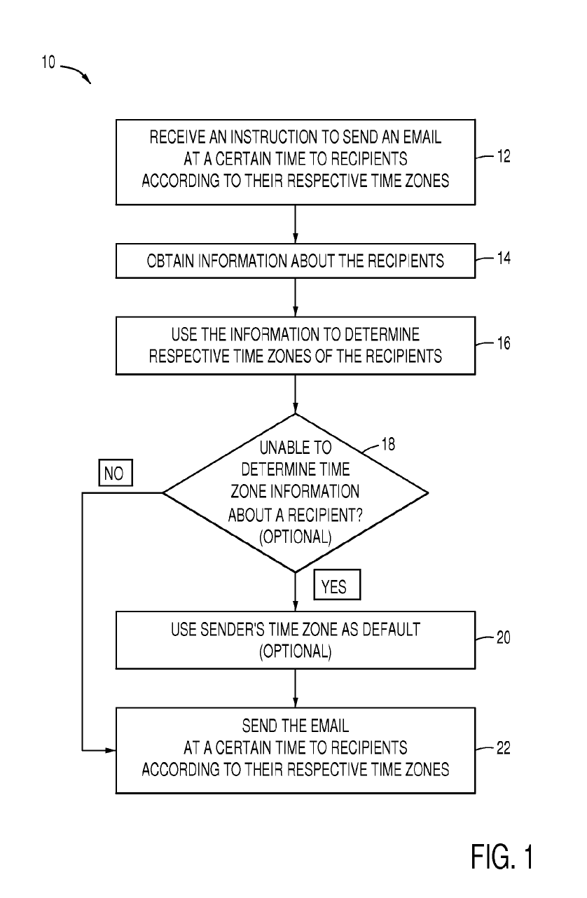

FIG. 1 is a flow diagram illustrating an overview of an exemplary method 10 according to the inventions. The exemplary method is explained in the context of an email service provider having customers (also referred to as “users”) who direct the email service provider to transmit an email(s) to respective subscribers of the customers. Each round of transmitting an email to subscribers of a customer is referred to herein as a “campaign” or “email campaign”. In some embodiments, a campaign may include more than one email with one or more of the emails in the campaign going to each subscriber of the customer.

Generally, a customer may set up a database on a server of the email service provider to host the customer's subscriber list(s). A customer's subscriber list may include entries for subscribers (also referred to as “recipients”) who may or are to receive emails from the customer via the email service provider. The customer may have a subscriber fill out a signup form typically including the subscriber's email address, name, and/or other information. The subscriber information may become part of the customer's database on the server of the email service provider and/or be otherwise stored or retained. Even though a subscriber may not directly input his or her Internet Protocol (IP) address into the signup form provided by the customer, the subscriber's IP address is generally submitted by a browser when transferring the information in the signup form to the email service provider. Thus, a subscriber's IP address may become a part of the information in the customer's database stored on the email service provider's server and/or otherwise stored or retained for accessibility.

Referring again to FIG. 1, the first action 12 of the exemplary method may be the receipt of an instruction from a customer to launch a campaign by sending an email(s) to a group of recipients so that each recipient receives the email(s) at a certain or selected time according to his or her time zone. In other words, a customer of the email service provider may direct it to send an email(s) to one or more of a group of the customer's subscribers so that the email arrives at a designated time whatever a particular subscriber's time zone. This instruction also may be referred to as an option in that the customer may choose, as part of an email campaign or otherwise, to have an email(s) reach the customer's recipients at a specified time(s) according to the recipients' respective time zones. In some cases, a customer may choose not to have the option of time zone delivery implemented with respect to one or more of the customer's recipients. For example, it may cost more to have a campaign delivered according to time zone, and a customer may choose to avoid the additional expense.

The inventions generally contemplate the sending of the same email(s) or substantially the same email(s) to a group of recipients, but exemplary embodiments may be used to send an email(s) to a single recipient, different emails to respective members of the group, and/or more than one email to one or more members of the group.

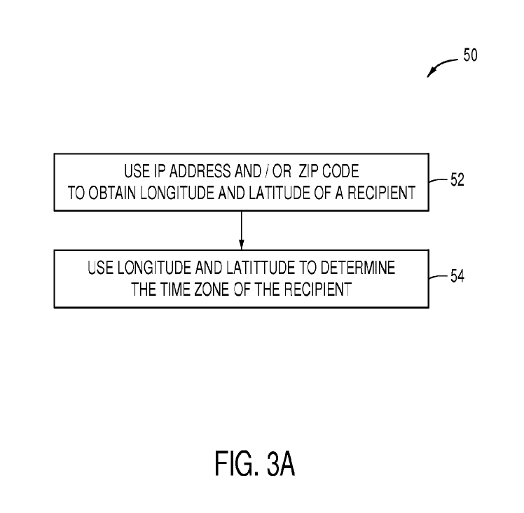

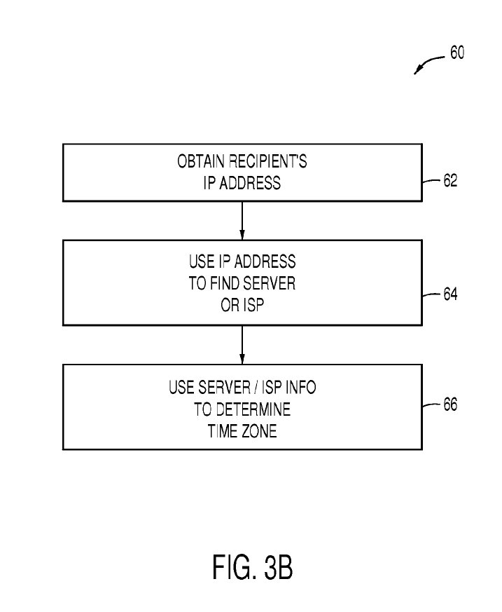

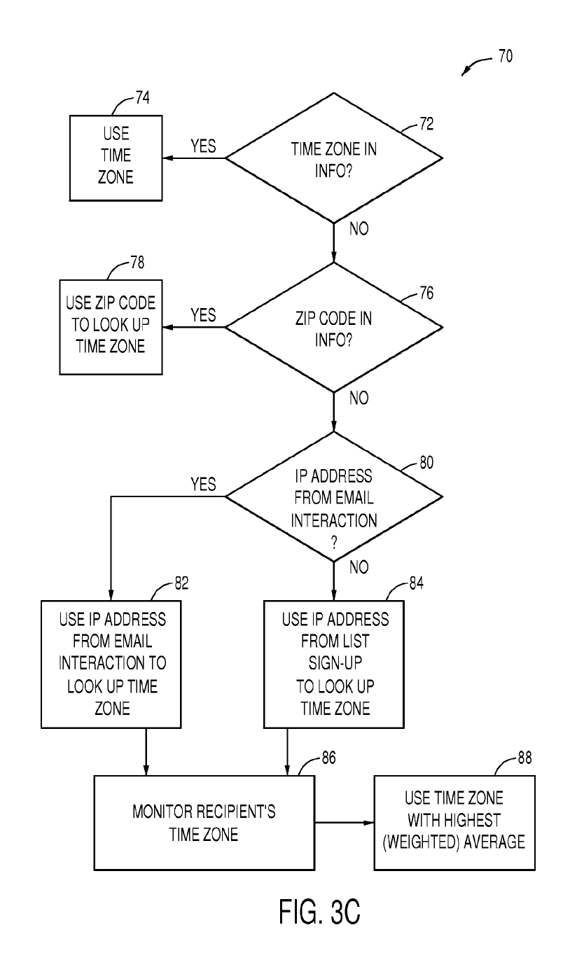

As action 14 of FIG. 1 shows, information about the recipient(s) may be obtained in response to receiving the instruction to send an email(s) according to the subscribers' time zones. In action 16 of FIG. 1, the information obtained about the recipients may be used to determine the respective time zones of the recipients. This may be done one recipient at a time, or otherwise. Further details about the information that may be obtained and the determination of the respective times zones are provided below in connection with FIGS. 3A-C. In some embodiments, actions 12 and 14 may be combined, or there may only be the action of determining the respective time zones of the recipients.

The exemplary embodiment described with respect to FIG. 1 includes a couple of optional actions. If the embodiment is unable to determine a time zone for a particular recipient as noted in action 18, then in action 20 the embodiment may use the sender's time zone as the default time zone for the recipient. The “sender's time zone” may be the time zone of the entity that directly causes the emails to be sent or sends the emails to recipients such as the email service provider. Alternatively, the “sender's time zone” may be the time zone of the entity that originates or authorizes the emails to be sent such as a customer of an email service provider. As yet another alternative, a particular time zone like the Eastern United States time zone may be chosen as the default time zone without regard to the time zone of the email service provider or the customer.

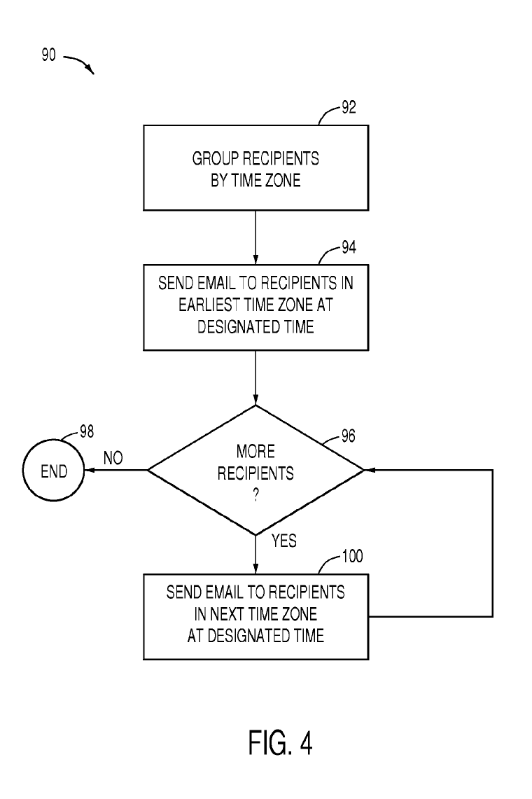

Using the time zone determination from action 16 or the default time zone from action 20, the email is transmitted in action 22 to the recipient(s) so that each recipient may receive the email at least at about the specified time in his or her respective time zones (barring unforeseen circumstances). Further, there may be no guarantee of delivery according to time zone. Additional information about action 22 is provided in the discussion relating to FIG. 4 below.

The email service provider may track the emails, accumulate information about the emails, and/or compile a campaign report. Various statistics about the emails may be logged such as open rates, click rates, bouncebacks, unsubscribes, and/or abuse reports. An exemplary embodiment of the inventions may keep track of a time zone email campaign according to time zone. The embodiment may provide a report on the time zone email campaign according to time zone. One way of providing such a report is to include statistics on a relevant map that shows time zones. The statistics for a particular time zone may be displayed directly on the corresponding time zone area on the map, and/or otherwise correlated to it. In the alternative, or in addition, an embodiment may keep track of, log, report and/or display information about the time zone email campaign according to zip code and/or other feature or point of reference.

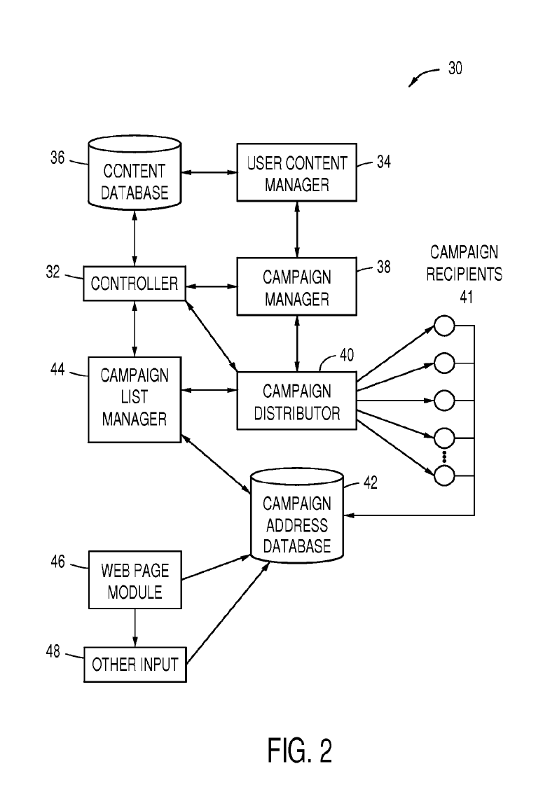

### System Overview—FIG. 2

The inventions may be used in many different environments of varying elements. An exemplary environment is an email communication system that provides tools for creating electronic mail messages that may be or may include advertising, advice, announcements, campaigns, news, newsletters, reports, solicitations, and/or other information. Such an email communication system also may provide tools for performing related tasks such as content creation, email address list management, email distribution, email tracking, follow-up tools such as reports and analysis as well as others.

The patent to Ayan, U.S. Pat. No. 6,769,002 is entitled a System and Methods for Multilevel Electronic Mail Communication Programs. This patent is incorporated herein by reference.

FIG. 2 illustrates a general structure of an exemplary email communication system 30 as may be used with the inventions. The “brains” or “smarts” of the system 30 is the controller 32 that may include at least part of the logic as necessary to implement and manage operation of the inventions in the exemplary system 30. Generally, the controller 32 interfaces with other elements of the system 30. The controller 32 may perform a variety of system administration and configuration functions. The controller 32 may configure the system 30 to define a campaign, a marketing program, an advertising plan, or like scheme, and their participants in accordance with the structures of the campaign, program, plan or scheme to be served.

Other elements of system 30 may include the user content manager 34. It may provide tools that enable a user to create and edit user content. The user content may be stored in the content database 36. The campaign manager 38 may provide tools that enable a user to create and edit email messages such as may be used in email campaigns. An email campaign is used herein to refer to the process of sending an email (generally the same email) to a particular group of people. The campaign manager 38 may interface with a campaign distributor 40 that may prepare and send the emails in a campaign to campaign recipients 41 using email addresses stored in address lists of a campaign address database 42. The campaign address database 42 and the content database 36 may be implemented using a single database system, or otherwise.

Addresses in the campaign address database 42 may be entered and organized using tools provided by a campaign list manager 44. Addresses may also be entered into the campaign address database 42 from web page modules 46 that may be placed on program participants' web pages to allow interested parties to subscribe and to receive email messages and campaigns on an opt-in basis.

As noted, the system 30 is an exemplary system. Other configurations for implementation and use of the inventions are possible.

### Determining Time Zone—FIGS. 3A-C

As noted above in connection with FIG. 1, information may be obtained about the recipients who are to receive the email(s) at the generally specific time according to their respective time zones. The information may be obtained in any appropriate manner. For example, a recipient may be part of or a subscriber to an email list. Information about the recipient may be stored and/or may be accessible through inclusion on the email list (or otherwise). In the exemplary embodiment, the information obtained about a recipient may include the recipient's internet protocol (IP) address³ and/or the recipient's zip code. ³ “An IP address is a unique address that certain electronic devices use in order to identify and communicate with each other on a computer network utilizing the Internet Protocol standard (IP) standard—in simpler terms, a computer address . . . . The IP address acts as a locator for one IP device to find another and interact with it. It is not intended, however, to act as an identifier that always uniquely identifies a particular device. In current practice, an IP address is not always a unique identifier, due to technologies such as dynamic assignment and network address translation.” from Wikipedia, http:en.wikipedia.org/wiki/Ip_address on Mar. 29, 2008.

In some cases, the exemplary embodiment may store or have ready access to a recipient's time zone. The recipient's time zone information may have been obtained from an earlier use of the exemplary embodiment. In other words, once a recipient's time zone is determined, it may be stored and/or in ready access for use in sending email to the recipient at the specific time in his or her time zone. A recipient's time zone may be obtained as needed and/or stored in other manners as well. In case the embodiment already has the recipient's time zone information, then the embodiment may simply obtain the recipient's time as part of action 14 and skip the remaining actions.

FIG. 3A provides a first exemplary process 50 of carrying out action 16 in FIG. 1, which is to use the information about the recipients to determine respective time zones of the recipients. In particular, in action 52 the IP address and/or zip code of a recipient may be used to obtain further information such as the longitude and latitude of the recipient. In action 54, the obtained longitude and latitude may be used to determine the time zone of the recipient. For actions 52 and 54, appropriate look up tables may be used to obtain the desired information.

FIG. 3B provides another exemplary process 60 of the carrying out action 16 in FIG. 1, which is to use the information about the recipients to determine respective time zones of the recipients. In particular, in action 62 a recipient's IP address may be obtained. The IP address may be obtained in any appropriate manner. For example, a recipient's IP address may be stored, in ready access, and/or determined as a result of the recipient's inclusion in an email list or group. Once the IP address is obtained in action 62, then in action 64 the IP address is used to find the server and/or internet service provider (ISP) serving the recipient's device. In action 66, the information about the server and/or ISP is used to determine the time zone of the recipient.

FIG. 3C provides another exemplary process 70 of carrying out action 16 in FIG. 1, which is to use the information about the recipients to determine their respective time zones. In particular, in action 72 the exemplary process checks whether it has time zone information for a recipient in storage or ready access. If so, then in action 74 the time zone information that is in storage or ready access is used as the time zone information for the recipient. If the result of action 72 is a finding that time zone information is not in storage or ready access, in action 76 a check may be carried out to determine if zip code information about the recipient is in storage or ready access. If so, then in action 78 the zip code information may be used to look up a time zone for the recipient. Appropriate look up tables may be used to obtain the desired information.

If zip code information is not in storage or ready access, then in action 80 the exemplary process may check whether it has an IP address for the recipient from email interaction (with the originator/initiator of the email and/or otherwise). For example, a subscriber may have an email interaction with a customer by becoming a part of the customer's list of email subscribers. If there is an IP address from email interaction, then in action 82 the IP address from the email interaction may be used to look up the time zone of the recipient. The determination of the recipient's time zone from the IP address derived from email interaction may be carried out in any appropriate manner, and/or as carried out in the process shown in FIG. 3B and discussed above.

Referring action to action 80, if there is no IP address from email interaction, then in action 84 an IP address for the recipient from a list sign-up may be used to look up the recipient's time zone. The determination of the recipient's time zone from the IP address derived from list sign-up may be carried out in any appropriate manner, and/or as carried out in the process shown in FIG. 3B and discussed above.

A time zone that is determined either from an IP address based on email interaction or an IP address from list sign-up is referred to herein as an “inferred time zone”. It is referred to as an “inferred time zone” because it may be based on information that may not completely accurately lead to determination of a recipient's time zone. To provide a more accurate determination of the recipient's time zone, the exemplary process in action 86 may monitor or log the recipient's time zone over time and in the course of sending emails (time zone emails and/or other emails). In other words, the process may keep track of the recipient's time zone(s) when sending emails to the recipient. When presented with the opportunity to send the recipient another email based on a selected time according to time zone, the process in action 88 may use the time zone for the recipient wherein the recipient was inferred to be or was present most often based on previous email campaigns (whether time zone or not, or otherwise).

Other ways of choosing a time zone for a particular recipient may be used—especially when information about past time zone email campaigns may be available for the particular recipient. For example, a recipient's time zone may be determined by the average of most recently recorded time zones for that recipient. The average may be a weighted average based on frequency and recent history (also referred to as “recency” or “recentcy”).

An example is now provided of the determination of a recipient's time zone based on weighted average with respect to frequency and recent history. Assume a recipient on a customer's list has an IP address correlated to New York City. The recipient opens some emails and clicks some links from that customer's campaigns. This activity generally indicates the recipient lives or is at least present when undertaking such actions in New York City. But a sudden change in the recipient's activity may indicate the recipient has changed to opening emails in Los Angeles. Has the recipient moved to Los Angeles so all further time zone emails should be sent to the recipient using Pacific Standard Time as the time zone? Or is the recipient merely on a visit to Los Angeles so that further time zone emails should be sent using Eastern Standard Time as the time zone?

A weighted average process may be used to determine whether to continue to send time zone emails according to the time in New York City or to change and send time zone emails according to the time in Los Angeles.

As part of the weighted average process (and/or for other reasons), the exemplary embodiment may keep a log of information about the recipient's email activity (opens, clicks, etc.). A recipient's time zone may be inferred from this activity. For the weighted average process, the information from the recipient's recent activity such as activity with respect to recent email campaigns may be considered. “Recent activity” may be defined in various ways. “Different” recent activity may be used depending upon the circumstances. For example, “recent activity” may be defined as campaigns from the last three months, or from the last five campaigns. A customer may launch a campaign every day, or may launch a campaign only every calendar quarter so the definition of “recent activity” may be made to be flexible to account for such differences.

Looking at a recipient's “recent activity”, the weighted average process determines the time zone where the recipient is active for each campaign. A score may be awarded to each determined time zone, but the score may depend on how recent the campaign was. Campaigns that are more recent may receive a high score, while campaigns that are less recent (within the time frame of the recent activity) may receive a low score. For example, assume the time frame for recent activity of a particular recipient is six weeks. A time zone inferred for a campaign that occurred within the past week receives 2 points. A time zone from a campaign that is 2-3 weeks old receives 1 point. A time zone from a campaign that occurred 4-6 weeks ago receives 0.75 points.

According to the scoring described in the previous paragraph, the weighted average process may reviews the following information for each example below regarding the recipient who may have moved to Los Angeles or be only visiting.

First Example—The recipient is determined to have moved to Los Angeles based on the campaign log below. The recipient is determined to have moved to Los Angeles because the time zone for Los Angeles scores higher (3 points/4 campaigns) than the time zone for New York City (1.5 points/4 campaigns).
Campaign 1—Email sent within the last week opened from L.A.=2 points.
Campaign 2—Email sent within the last 2-3 weeks opened from L.A.=1 point.
Campaign 3—Email sent within the last 4-6 weeks opened from N.Y.C.=0.75
Campaign 4—Email sent within the last 4-6 weeks opened from N.Y.C.=0.75

Second Example—The recipient is determined to be only visiting Los Angeles based on the campaign log below. The recipient is determined to be only visiting Los Angeles because the time zone for New York scores higher (3 points/5 campaigns) than the time zone for Los Angeles (2 points/5 campaign).
Campaign 1—Sent Apr. 17, 2008 opened from L.A.=2 points
Campaign 2—Sent Jan. 1, 2008 opened from N.Y.C.=0.75
Campaign 3—Sent Dec. 15, 2007 opened from N.Y.C.=0.75
Campaign 4—Sent Nov. 5, 2007 opened from N.Y.C.=0.75
Campaign 5—Sent Oct. 3, 2007 opened from N.Y.C.=0.75

Referring again to FIG. 3C, actions 86 and 88 may be optional to other embodiments, and/or more accurate determinations of a particular recipient's time zone may be made such as in other ways. If a time zone is undeterminable, and/or for other reasons, a default time zone may be used. A default time zone has been defined above.

### Send Email According to Time Zones

As noted above in connection with FIG. 1, the time zone determination from action 16 or the default time zone from action 20 may be used in transmitting the email in action 22 to the recipient(s) so that each recipient receives the email at the specified time in his or her respective time zones. FIG. 4 illustrates an exemplary method 90 of carrying out the action 22 of transmitting the email to the recipient(s) according to time zones. In particular, in action 92 the recipients may be grouped according to time zone. For example, a customer's list of subscribers may be broken up into pieces (also referred to as “parts” or “groups”) with each piece having subscribers in the same time zone. This division may be accomplished based on a time zone parameter being included with respect to each subscriber and/or otherwise. All those subscribers having the same time zone parameter may be grouped into the same piece or part of the list.

Action 94 begins the actions of sending the campaign email to the recipients according to their respective time zones with the email first being sent to the recipients in the earliest time zone. For example, each piece of the customer's subscriber list may be sent as a unit based on its time zone. Action 96 may check for additional groups of the subscriber's list, and if there are none, then the process may end in action 98. If there are additional groups to be sent the email, then in action 100 the email may be sent to the group of recipients at the designated time in the next (chronologically) time zone. For example, if the first round of campaign emails was sent for delivery at 9 A.M. E.S.T. to recipients present in that time zone, then the next round may be sent for delivery at 9 AM Central Standard Time (C.S.T.) to recipients present in that time zone. If there are no recipients in the C.S.T. time zone, then the exemplary embodiment may skip delivery of the email for that time zone. The exemplary embodiment may skip to the next time zone chronologically having recipients present to whom the email of the campaign is to be sent at the appropriate time according to the recipients' respective time zones. An alternative embodiment may send all (or some) of the emails at the same time, but provide that the emails be delivered (and/or received) according to time zone.

Referring again to FIG. 4, in action 96, the process may return to check for additional groups and the process repeats as appropriate until it may end in action 98.

### Statistics, Data Relevant to the Campaign

The process of sending one or more emails to subscribers on a customer's list may be referred to as a campaign. Email service providers typically provide information such as statistics and data about a campaign to the subscriber. For example, the statistics and data may include the number of recipients, how many recipients opened the email, what time the email was transmitted to each respective recipient, what time recipients respectively opened the emails, open rates, click rates, bouncebacks, unsubscribes, abuse reports, etc.

The exemplary embodiments of the inventions may provide the same type of statistics and data for a customer with respect to an email campaign that sends an email according to the recipients' respective time zones. In addition, the exemplary embodiments may provide additional and/or different information and/or information specific to the transmission of the email according to the time zones. For example, an exemplary embodiment may provide a customer with information about the groups of the campaign's list of email subscribers based on time zone. The provided information may identify just the group per time zone, and/or may identify each of the subscribers by time zone. Similarly, the provided information may include statistics and data by reference to the time zone of the email recipient and/or group to which the email recipient belongs. Additional or different information may be provided in the same manner.

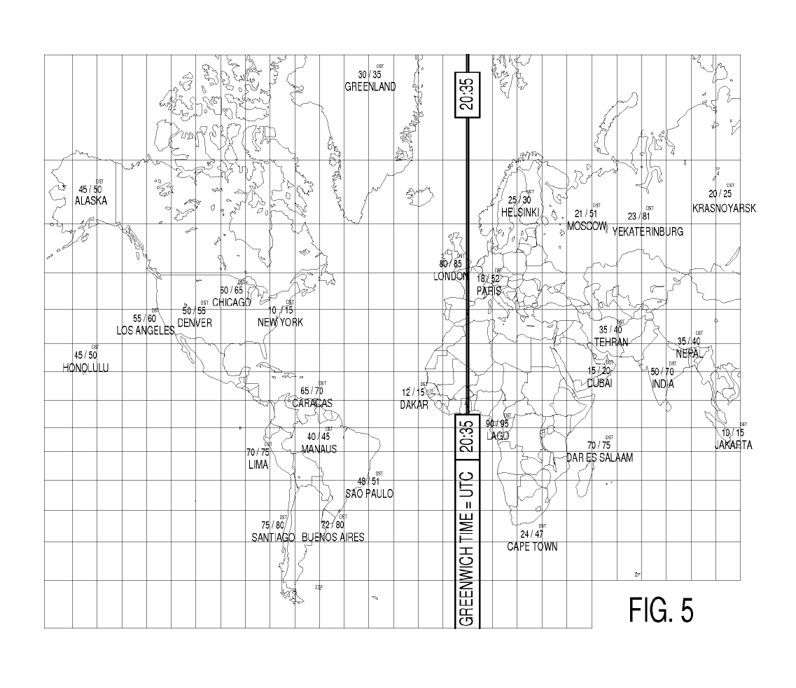

FIG. 5 is an exemplary time zone map of part of the world. FIG. 5 illustrates that information about a time zone email campaign may be displayed in a visually interesting and easy to comprehend format such as by including the information directly on a time zone map. FIG. 5 is an exemplary time zone map including open rates/click rates by time zone for an exemplary email campaign. The open rate/click rate for a particular time zone is shown on or near the pertinent time zone depicted on the map. Other or additional information and statistics may be displayed. The information may be displayed as it is obtained and reported so that customer looking at the map over time may watch the time zone map be populated with relevant information according to time zone. Alternatively, the map may not be presented or available until all (or a selected percentage) of the information is included on the map. All or less than all time zones and/or their respective time zone information may be displayed.

The exemplary time zone map shown in FIG. 5 may be made interactive in an exemplary embodiment. For example, the time zone map may be devoid of email campaign information until a user activates the map, or a particular area of the map. As another example, a user may be able to choose to view all available information by time zone, or only selected portions thereof. In a further example, a user may be able to pick and choose among time zones for display of information that may vary from selected time zone to time zone. In an embodiment, the user may be able to view information from more than one email campaign such as a historic record of email campaigns according to time zone. The map may have other features as well.

### CONCLUSION

The exemplary embodiments of the present inventions were chosen and described above in order to explain the principles of the invention and their practical applications so as to enable others skilled in the art to utilize the inventions including various embodiments and various modifications as are suited to the particular uses contemplated. For example, the actions of the exemplary embodiments may occur in an order other than specified herein. Some actions may be omitted. Other actions may be included. The examples provided herein are not intended as limitations of the present invention. Other embodiments will suggest themselves to those skilled in the art.

We claim:

1. A method for sending an electronic mail message (email) so that a recipient receives the email at a selected time in the recipient's time zone, comprising:
receiving an instruction to send an email to a recipient for receipt at a selected time where the time zone of the recipient is unknown;
obtaining information about the recipient to determine the unknown time zone;
using the obtained information to determine the unknown time zone; and
transmitting the email to the recipient so the recipient receives the email at the selected time in the determined time zone.

2. The method of claim 1, wherein the obtained information comprises a zip code of the recipient or an area code of the recipient.

3. The method of claim 1, wherein the obtained information comprises an Internet Protocol (IP) address of the recipient,
wherein the IP address is used to identify a server or an internet service provider (ISP) serving the IP address,
wherein the identity of the server or the ISP is used to determine a location for the server or the ISP, and
wherein the location for the server or the ISP is used to determine the unknown time zone.

4. A method to deliver an email so recipients receive the email at a selected time according to their respective time zones, comprising:
obtaining information about each of the recipients;
using the obtained information to determine respectively a time zone for as many recipients as possible;
if a time zone cannot be determined for a recipient, selecting a default time zone for that recipient; and
sending the email to the recipients so the recipients receive the email at the selected time according to their respectively determined time zones or to the default time zone.

5. The method of claim 4, wherein obtaining information about each of the recipients comprises:
monitoring email activity of a particular recipient; and
based on the monitoring, determining in which time zones the particular recipient receives emails.

6. The method of claim 5, wherein using the obtained information comprises using the determined time zones to determine the time zone for the particular recipient to be the particular time zone in which the particular recipient receives more emails than any other time zone.

7. The method of claim 5, wherein using the obtained information comprises using the determined time zones to determine the time zone for the particular recipient to be a time zone having a highest weighted average among the determined time zones.

8. The method of claim 7, wherein the time zone having the highest weighted average is determined based on frequency of receipt of emails in that time zone and recent history of receipt of email campaigns in that time zone.

9. The method of claim 4, wherein sending the email to the recipients comprises:
grouping the recipients by their time zones;
sending the email to recipients in earliest time zone at the selected time in the earliest time zone.

10. The method of claim 4, further comprising:
after sending the email to the recipients, monitoring open rates of the email by the recipients by the determined time zones; and
displaying the open rates by the determined time zones on a map of time zones.

11. The method of claim 4, further comprising:
after sending the email to the recipients, monitoring click rates of the email by the recipients by the determined time zones; and
displaying the open rates by the determined time zones on a map of time zones.

12. A method to increase likelihood of a recipient opening an email, comprising:
receiving a time determined to be most likely at which the recipient is going to open the email;
determining a time zone for the recipient; and
transmitting the email to the recipient at the determined time according to the determined time zone of the recipient.

13. The method of claim 12, wherein determining the time zone for the recipient comprises determining the time zone from received information about the recipient.

14. The method of claim 12, wherein determining the time zone for the recipient comprises determining the time zone from zip code information about the recipient.

15. The method of claim 12, wherein determining the time zone for the recipient comprises determining the time zone from an internet protocol address relating to the recipient.

16. The method of claim 12, wherein determining the time zone for the recipient comprises determining the time zone from email activity of the recipient.
